(19) United States
(12) Patent Application Publication
(10) Pub. No.: US 2004/0234792 A1
(43) Pub. Date: Nov. 25, 2004

(54) Dry lamination method using non-reactive, monomer-free lamination adhesives

(76) Inventors: Conrad Henkens, Windischeschenbach (DE); Karl Pollmann, Krummennaab (DE)

Correspondence Address: WENDEROTH, LIND & PONACK, L.L.P., 2033 K STREET N. W., SUITE 800, WASHINGTON, DC, 20006-1021, US

(21) Appl. No.: 10/476,544

(22) PCT Filed: Apr. 11, 2002
(86) PCT No.: PCT/EP02/04031

(51) Int. Cl. B32B 15/08

(52) U.S. Cl. 428/461; 428/500; 156/269

(57) ABSTRACT

The invention relates to flexible film composites comprising two or more layers that are characterized by exceptionally high composite strength and high chemical resistance. The inventive film composites are especially useful for packaging sensitive or aggressive goods and products as they do not release any harmful migration products into the product.

The invention relates to flexible foil composites, in particular for packaging purposes.

Foil composites are extensively employed in packaging technology, since special properties of the packaging can be attained through suitable combinations of the individual foils in the composite.

For example by using a metal foil, for example an aluminum foil, packaging foils impermeable to light, vapor and flavoring agents can be produced for example for products and merchandise sensitive to light or moisture, but which may lack resistance to aggressive packaged materials.

While films of synthetic material, for example of thermoplastic synthetic material, such as polypropylene, polyethylene, polyester, polyamide or polyvinyl chloride films, are substantially chemically sufficiently resistant, they are, however, most often not adequately impermeable to vapor and flavoring agents and can only through additives be finished such that they are largely opaque. Synthetic films most often, further, lack sufficient dimensional stability for diverse packaging purposes.

Composites of metal foils with synthetic material films or different synthetic films combine the above listed advantages of the individual types of foils and films. For most packaging purposes two-layered or three-layered composites are predominantly employed. But for specific application purposes multilayered composites are also conceivable.

Such composites are conventionally produced utilizing reactive adhesives, for example such based on polyurethanes or epoxy resins. However, in the production and the processing of the polyurethane adhesives complete polymerization is not possible such that residual monomers can remain in the adhesive.

These isocyanate monomers, which are most often aromatic isocyanates, subsequently form aromatic amines in the composite, which are carcinogenic and can migrate into the product. Furthermore, under unfavorable conditions backreactions may occur which can also lead to aromatic amines.

This is not only disturbing but also extremely objectionable and presents risks in particular when used for packaging food items, baby and infant food, but also in pharmaceutical and cosmetics packaging.

In addition, when using reactive adhesive systems, a certain curing time is required after the foil composite has been produced, such that the foil composite cannot be immediately processed further, thus it cannot be cut, trimmed or shaped. This means great restrictions of economy, high costs, inter alia through the necessary storage time, and also high logistics expenditures in the fabrication of such foil composites.

A further possibility for producing flexible foil composites is the use of an extrusion coating method. But the disadvantage of this method is that relatively large quantities of laminating adhesives must be used involving application quantities of approximately 15 g/m². The method is further relatively complicated and, due to the large equipment and energy expenditures, not suitable for small lot sizes and is economically not justifiable.

The task of the invention is therefore providing a flexible two- or multilayered foil composite structured such that the side of the foil composite facing the item to be packaged is selected such that potentially migrating material from this foil of the foil composite is harmless and in which, further, objectionable migrates from the foil composite itself, thus either from the laminating means or from the films/foils, cannot reach into the packaged goods. Furthermore, the further processing, thus cutting, trimming, shaping and/or imprinting, of the foil composite is to be possible immediately after its production.

Therefore the subject matter of the invention are two- or multilayered flexible foil composites comprising one or more films of synthetic materials and optionally one or more metal foils, characterized in that at least the film facing the item to be packaged, is a synthetic film, which by means of a laminating adhesive in the form of a dispersion or solution, derived from the composition of the film, is bonded in a dry laminating process with one or several synthetic films and/or metal foils.

The synthetic film facing the item to be packaged can be a polyolefin film, for example a polypropylene or polyethylene film or a polyvinyl chloride film. Preferred are polypropylene films and polyvinyl chloride films.

Depending on the application purpose, in particular the required stability, tearing strength, resistance and the like, these inner films have a thickness of approximately 50 μm to 120 μm, preferably 12 to 80 μm, especially preferred 20 μm to 60 μm.

This inner film is bonded with at least one further synthetic film or metal foil.

Further synthetic films to be considered for use are for example polyester or polyamide films. Depending on the application purpose, these films can have a thickness of 5 to 50 μm, preferably 10 to 25 μm.

As metal foils preferably aluminum or copper foils can be used. These foils can have a thickness of 5 to 150 μm, preferably 7 to 60 μm, especially preferred 15 to 45 μm.

The inner film is connected with the further films/foils with a laminating adhesive variable according to the composition of the film.

To connect a polypropylene or polyethylene film with a metal foil or a polyester or polyamide film, a polypropylene or polyethylene dispersion is for example utilized as the laminating adhesive. This polypropylene dispersion has preferably a viscosity of 50 to 500 mPas and a specific weight of 0.75 to 0.85 g/cm³. The content of solids of the polypropylene dispersion is preferably 10 to 20%. The polymer is preferably dispersed in aliphatic hydrocarbons, preferably having a high boiling point.

The polyethylene dispersion is preferably an aqueous dispersion with a viscosity of 250 to 1000 mPas and a solids content of 10 to 60%.

To connect a polyvinyl chloride film with a further synthetic film or a metal foil, solutions of a terpolymers comprised of vinyl chloride maleic acid and vinylacetate or vinyl alcohols are, for example, utilized.

Possible solvents are for example ethyl acetate, optionally mixed with acetone.

After removing the solvent, the laminating adhesive according to the invention preferably has a defined melting range, within which the dry lamination subsequently takes place.

The corresponding laminating adhesive polymer dispersion or the corresponding laminating adhesive polymer solution is used in quantities of approximately 2 to 5 g/m².

An improvement of the adhesion between two films/foils of the foil composite can optionally be attained by using an adhesion promoter. Possible for use is a commercially available adhesion promoter, for example A1120 by OSI. The adhesion promoter is applied in a quantity of <0.5 g/m², preferably <0.1 g/m².

This composite of an inner synthetic film and a further synthetic film or metal foil, preferably an aluminum foil, on the outer side facing away from the item to be packaged, can optionally be additionally bonded with one or several further synthetic films, for example polyolefin, polyester or polyamide films.

In this case the above described laminating adhesive can be utilized for the lamination, optionally using an adhesion promoter.

If the foil/film facing away from the item to be packaged, of the above described two-layered composite is a metal foil, in particular an aluminum foil, additional synthetic film and/or metal foils can optionally also be laminated on in conventional manner, for example utilizing reactive adhesion systems, since the metal foil forms a barrier layer against the migration of undesirable monomer components and/or additives and/or fillers and admixtures of the adhesion system.

However, the lamination system according to the invention is preferably used.

A further subject matter of the invention is a method for the production of the two- or multilayered flexible foil composite according to the invention, which is characterized thereby that onto the provided synthetic film or metal foil the dispersion or the solution of the laminating adhesive is applied, subsequently the dispersion agent or solvent is completed evaporated in a drying tunnel, whereupon the film/foil is bonded under pressure in a laminating station at the melting temperature of the dry laminating means agent with the second synthetic film or a metal foil, and optionally, in further steps, this second synthetic film or metal foil is bonded with further synthetic films and/or metal foils.

A further subject matter of the invention is an arrangement for carrying out the method according to the invention, characterized in that the arrangement is comprised of a feed-out station 1 for providing the first film, an application device 2 for applying the solution or dispersion of the laminating means, a drying tunnel 3, in which the laminating adhesive is dried until it is free of solvent, a second feed-out station 4 for providing the second foil to a laminating station 5 to bond the first film/foil with the second film/foil and subsequent further processing units 6.

These further processing units can be, for example, a wind-up station for winding the composite, a cutting or trimming station, a printing station or also a further arrangement for producing a multilayered composite.

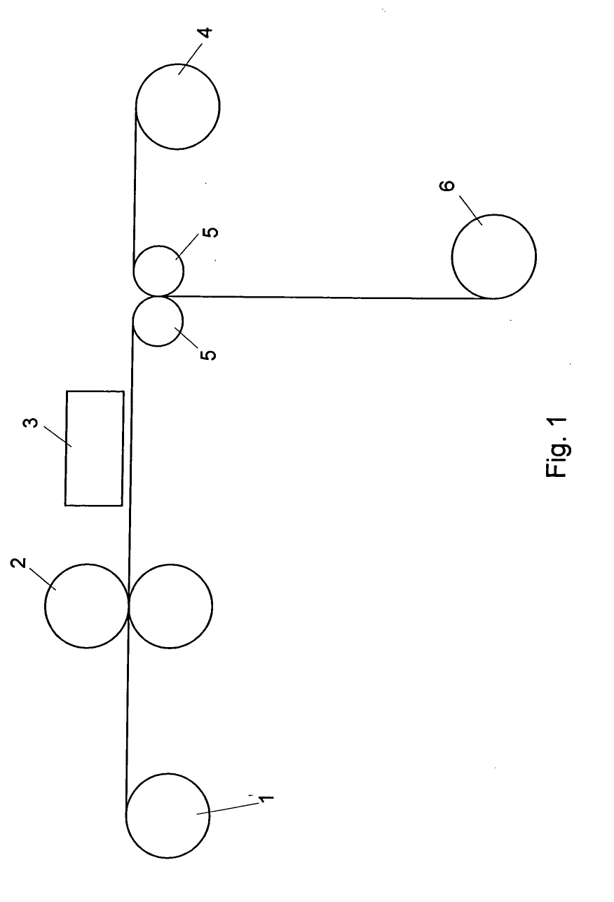

Such an arrangement is depicted schematically in FIG. 1, in which, here a wind-up station is shown as a further processing unit 6.

The second synthetic film can optionally have been treated with an adhesion promoter. If further films/foils are laminated onto it according to the inventive method, each additional foil/film can optionally be treated with an adhesion promoter. When using other laminating systems, for example reactive systems, for producing the connection of a two-layered flexible foil/film composite with additional synthetic films and/or metal foils, produced according to the inventive method, the treatment of the films/foils, subsequently laminated on, with the adhesion promoter can optionally be omitted.

For carrying out the method, the first foil, for example an aluminum foil, is provided from the feed-out station 1, and in the application device 2 a solution or dispersion of the laminating adhesive is applied.

The application can take place in any conventional manner by means of spreading, spraying, printing (low-pressure, flexographic, screen printing) or roller application techniques.

Depending on the solvent or dispersion agent, the laminating adhesive is dried at increased temperature in the drying tunnel 3. The Al foil treated in this manner is subsequently laminated in the laminating station 5 at increased temperature, for example at approximately 110 to 200° C., at a pressure of approximately 20 to 45 N/cm with a synthetic film provided by the feed-out station 4 under pressure.

The rate of transportation can be 40 to 180 m/min, preferably 80 to 140 m/min.

The temperature in the laminating station is preferably approximately 120 to 190° C. and the pressure approximately 25 to 40 N/cm.

Following the laminating station, the flexible foil composite is completed and can immediately be further processed. No further curing, reaction or storage times are required. The flexible foil composite can subsequently be cut, trimmed or shaped immediately.

For example, the foil composite can subsequently be immediately imprinted by means of a known printing process or be otherwise finished.

However, it is also possible to supply a corresponding film/foil already printed or finished to the laminating station, however, care must be taken that the utilized printing inks are sufficiently heat-resistant, such that they are not degraded in the laminating station by the laminating means-dependent temperatures.

The flexible foil composite is in particular distinguished by the high bond strength, by the complete absence of harmful migrates, excellent chemical resistance and excellent capability to be shaped. The composites can optionally be sterilized depending on the employed synthetic films.

The flexible foil composites according to the invention have a bond strength which is independently of the substrate of ≧6 N/15 mm (cohesive failure), preferably ≧8 N/15 mm (according to DIN 53357).

For example for the production of blister packaging the flexible foil composite can be deep-drawn, and the deep-drawing quality is markedly better than the deep-drawing quality of the flexible foil composites known until now, i.e. the composite can be drawn deeper and more exactly without impairment of the properties of the composite than the previously known flexible foil composites.

Due to their above described properties, the flexible foil composites according to the invention are in particular suitable for use for packaging purposes in the food, feed or pharmaceutical or cosmetics industry, as packaging means in the construction industry, the chemical industry but also as packaging means for cleaning agents, for gardening and agricultural needs, such as soil, fertilizer, mulch or agricultural chemicals.

Examples of such applications are:

in the food industry: milk and dairy products, beverages, in particular also fruit juice beverages, vegetable and salads, in particular ready-to-eat products, for example in marinades or with additives to increase the keeping properties;

in the feed industry: packagings for animal feed, dry feed or moist feed and feed supplementary means, as well as for animal care products;

in the pharmaceutical industry: packagings for medications, tablets, dragees, salves, gels, emulsions, enemas, dose packages for liquid pharmaceutical formulations, such as juices, syrups, drops and the like;

in the cosmetics industry: packagings for body and facial, cleansing and care products and sample packages in each instance of liquid, cream or emulsified, foamy or solid products, such as shower bath products, shampoos, lotions and the like;

in the construction industry: packagings for solid, powder, liquid or viscous building material or building additive materials, such as lime, cement, plasticizers, hardening inhibitors, mold and fungus control agents and the like;

in the chemical industry: as packaging for liquid and solid synthesis starting materials, catalysts, fertilizers, plant protection agents, acidic or basic solutions, cleaning agents and the like;

The foil composites according to the invention can further also be utilized as industrial foils/films for example also as packaging for battery acid and the like. This list of application feasibilities of the flexible foil composites according to the invention is not exhaustive but only provided as examples.

### EXAMPLES

### Example 1

onto an aluminum foil with a thickness of 20 μm in the application device was applied a polypropylene dispersion in Isopar M (C9-C12-i-alkane) as the laminating adhesive with a solids content of 12% and a viscosity of 120 mPas.

The laminating adhesive was dried in the drying tunnel at 180° C.

In the laminating station the aluminum foil treated in this manner was brought together with a polypropylene film of a thickness of 20 μm and laminated at a pressure of 20 N/cm and a temperature of 180° C.

The rate of transportation was 140 m/min.

The flexible foil composite produced thus was subsequently wound up and samples were taken to determine the bond strength and the migrates.

The flexible foil composite has a bond strength of 12 N/15 mm according to DIN 53 357. The migrates of the composite were determined in dodecane (60° C., 2 days) by gas chromatography relative to polypropylene film as a reference. No qualitative differences could be found.

### Example 2

a polyester film of a thickness of 15 μm was coated with 0.08 g/m² of the adhesion promoter A1120 (OSI) and subsequently coated with a laminating adhesive comprised of a polypropylene dispersion in Isopar M with a solids content of 10% and a viscosity of 70 mPas. The laminating adhesive was subsequently dried in the drying tunnel at 180° C.

In the laminating station the polyester film treated in this manner was brought together with a composite foil produced according to Example 1 and laminated at a temperature of 180° C. at a pressure of 20 N/cm.

The completed three-layered flexible foil composite has a bond strength between polyester and aluminum layer of 7 N/15 mm.

The following composites were produced in analogous manner:

TABLE 1

| | Outer | | Middle | | Inner |
|---|---|---|---|---|---|
| Example | film | Laminating means | foil | Laminating adhesive | film |
| 3 | PET | adhesion promoter/PP | Al | polyethylene | PE |
| | (20 μm) | dispersion (viscosity | (20 μm) | dispersion (visc: | (20 μm) |
| | | 250 mPas) | | 500 mPas) | |
| 4 | PA | adhesion promoter/PP | Al | terpolymer solution | PVC |
| | (20 μm) | dispersion (viscosity | (30 μm) | | (60 μm) |
| | | 220 mPas) | | | |
| 5 | PA | adhesion promoter/PP | Al | PP dispersion (visc: | PP |
| | (15 μm) | dispersion (viscosity | (12 μm) | 210 mPas) | (25 μm) |
| | | 210 mPas) | | | |
| 6 | PET | adhesion promoter/PP | — | — | PP |
| | (20 μm) | dispersion (viscosity | | | (20 μm) |
| | | 270 mPas) | | | |
| 7 | PET | adhesion promoter/PE | — | — | PE |
| | (20 μm) | dispersion (viscosity | | | (20 μm) |
| | | 520 mPas) | | | |
| 8 | PET | adhesion promoter/PP | Al | PP dispersion | PP |
| | (20 μm) | dispersion (viscosity | (60 μm) | (visc: 210 mPas) | (60 μm) |
| | | 270 mPas) | | | |

The following bond strengths were measured:

TABLE 2

| | | | outer film/ |
|---|---|---|---|
| Example | outer film/middle foil | middle foil/inner film | inner film |
| 3 | 6 N/15 mm | 6 N/15 mm | |
| 4 | 14 N/15 mm | 11 N/15 mm | |
| 5 | 14 N/15 mm | 11 N/15 mm | |
| 6 | | | 8 N/15 mm |
| 7 | | | 8 N/15 mm |
| 8 | 6 N/15 mm | 16 N/15 mm | |

1. Two- or multilayered flexible foil composites comprised of one or several synthetic films and optionally one or several metal foils, characterized in that at least the film facing the item to be packaged is a synthetic film, which is bonded with one or several synthetic films and/or metal foils by means of a laminating adhesive, derived from the composition of the film, in the form of a dispersion or solution, in a dry lamination process.

2. Two- or multilayered flexible foil composites as claimed in claim 1, characterized in that the synthetic film facing the item to be packaged is comprised of polyethylene, polypropylene or PVC.

3. Two- or multilayered foil composites as claimed in one of claims 1 or 2, characterized in that as the metal foil an aluminum foil or a copper foil is used.

4. Two- or multilayered foil composites as claimed in one of claims 1 to 3, characterized in that the synthetic film facing away from the item to be packaged is comprised of polyamide or polyester.

5. Two- or multilayered flexible foil composites as claimed in one of claims 1 to 4, characterized in that at least one film/foil of the foil composite is imprinted.

6. Two- or multilayered foil composites as claimed in one of claims 1 to 5, characterized in that the synthetic film facing the item to be packaged has a thickness of 5 to 120 μm.

7. Method for the production of the two- or multilayered flexible foil composites according to the invention, characterized in that onto the provided synthetic film or metal foil the dispersion or the solution of the laminating adhesive is applied, subsequently in a drying tunnel the dispersion means or solvent is completely evaporated, whereupon the foil/film is bonded in a laminating station at the melting temperature of the dry laminating means at a pressure with the second synthetic film or a metal foil and optionally in further steps this second synthetic film or metal foil is bonded with further synthetic films and/or metal foils.

8. Method as claimed in claim 7, characterized in that the laminating adhesive is applied in quantities of 2 to 5 g/m².

9. Method as claimed in one of claims 7 or 8, characterized in that an adhesion promoter is applied in order to improve the adhesion.

10. Method as claimed in claim 9, characterized in that the adhesion promoter is applied in a quantity of ≦0.1 g/m².

11. Method as claimed in one of claims 7 to 10, characterized in that the composite is produced in the laminating station at a temperature of 110 to 200° C. and at a pressure of 25 to 40 N/cm.

12. Method as claimed in one of claims 7 to 11, characterized in that the transportation rate in the lamination station is 40 to 180 m/min.

13. Method as claimed in one of claims 7 to 12, characterized in that the foil composite is subsequently further processed in-line, in particular is printed and/or cut and/or trimmed and/or shaped.

14. Method as claimed in one of claims 7 to 12, characterized in that the foil composite is subsequently further processed in separate working steps, in particular printed and/or shaped and/or cut and/or trimmed.

15. Arrangement for carrying out the method according to the invention, characterized in that the arrangement is comprised of a feed-out station 1 for providing the first film/foil, an application device 2 for applying the solution or dispersion of the laminating adhesive, a drying tunnel 3, in which the laminating adhesive is dried until it is free of the solvent, a second feed-out station 4 for providing the second film/foil to a laminating station 5 in order to bond the first with the second foil/film and succeeding further processing units 6.

16. Use of the flexible foil composites as claimed in one of claims 1 to 6, as packaging materials in the food, feed, pharmaceutical or cosmetics industry, for aggressive commercial or agricultural products, in the fertilizer and plant protection agent industry, in the construction material industry and in the chemical industry.
